(19) United States
(12) Patent Application Publication
(10) Pub. No.: US 2007/0275758 A1
(43) Pub. Date: Nov. 29, 2007

(54) Mobile Telephone and a Method of Operating the Mobile Telephone

(75) Inventors: Niels Peter Emme, Hellerup (DK); Thomas Kaupert, Berg (CH)

Correspondence Address: BANNER & WITCOFF, LTD., 1100 13th STREET, N.W., SUITE 1200, WASHINGTON, DC, 20005-4051, US

(73) Assignee: NOKIA CORPORATION, ESPOO (FI)

(21) Appl. No.: 10/580,537

(22) PCT Filed: Nov. 28, 2003
(86) PCT No.: PCT/DK03/00818

§ 371 Date: Apr. 13, 2007

(51) Int. Cl. H04M 1/00

(52) U.S. Cl. 455/558; 455/572

(57) ABSTRACT

A mobile telephone having two cards, where it is desired to maintain a first card in its operative position and maintain a predetermined activity or functionality when removing or replacing the second card. If the first card is to be removed, however, the predetermined activity of functionality is inactivated. The second card may be tilted out of its operative position, and the first card may have its path of removal blocked by a battery feeding power to at least the predetermined activity or functionality, which preferably uses data provided on the first card during operation.

The present invention relates to mobile telephones having therein two cards, such as SIM cards, memory cards (MMC or the like), payment cards (credit cards or debit cards) or other electronically readable/writable cards. More particularly, the invention relates to the facilitating of removal of one of the cards while at least part of the operation of the telephone is active.

Dual card telephones and card readers may be seen in U.S. Pat. Nos. 6,062,887, 6,042,002, 6,454,164, 6,012,634, 6,330,151, 5,987,325, and 6,471,550 as well as in EP-A-1 039 406 and 1 058 202. The pertinent parts of this prior art, however, relates to telephones where both cards are disengaged and rendered inoperative when only a single card is to be removed.

Applicant's mobile telephone, model 9210, comprises two cards where the battery blocks the SIM card but where the MMC card may be removed while keeping the battery in place. In this telephone, however, the cards are not overlapping, which reduces the magnetic shielding of the cards and requires more surface space for the cards and card readers.

In a first aspect, the invention relates to a mobile telephone comprising:
means for providing a predetermined activity or functionality of the telephone,
a first and a second data providing and/or storing card each having one or more contacting surfaces or pads,
means for holding the first and a second cards in an operative position, where the cards are at least substantially parallel and at least partly overlap each other,
means for contacting the contacting surfaces or pads of each of the first and second cards,
preventing means having two positions, a first of the positions preventing the first card from being removed from the operative position, and the second position allowing removal of the first card from the operative position, the preventing means being adapted to deactivate the providing means when in the second position, and
the preventing means, in its first position, allowing removal of the second card from the operative position.

In the present context, overlapping preferably means overlapping when projected onto a predetermined plane, such as a plane defined by a plane of one or both of the cards.

Also, “parallel” will mean that both cards have their main planes at least substantially parallel.

Normally, the predetermined activity or functionality of the telephone is an activity or functionality using the first card, such as data present on the first card, and/or in a manner so as to store data on the first card.

The overlapping of the cards has the advantage of electrically or magnetically shielding the cards from the surroundings, such as from an antenna of the mobile telephone. Additional shielding may be provided by the holding means, as these may be made of a magnetic material, such as a metal, and be provided so as to at least cover a part of the surface of one or both of the cards.

In the preferred embodiment, the preventing means comprise a battery feeding power to the providing means in its first position, the second position being a position in which the battery has been removed from the telephone. Thus, the first card can only be removed upon removal of the battery. In that manner, the operation which is desired turned off may be an operation powered by the battery, whereby this is automatically turned off before removal of the card.

Preferably, the first card is translatable into and out of the operative position along a linear path, the preventing means blocking the linear path out of the operative position when in its first position. Thus, the preventing means—preferably the battery—will be positioned in the path which the first card takes during removal.

In the preferred embodiment, the telephone further comprises means for removing the second card, the removing means being adapted to tilt the second card from the operative position into an inoperative position. This tilting has the advantage that it may be performed even though the preventing means are positioned adjacent to the second card in order to block removal of the first card.

Preferably, the removing means are adapted to translate the second card, prior to tilting, from the operative position into an intermediate position, the telephone further comprising means for preventing tilting of the second card when in the operative position and allowing tilting of the second card when in the intermediate position.

Thus, the second card is locked in its operative position but may be removed without activating the preventing means and thereby stopping the activity/functionality.

An advantage of this translation may be achieved when means are provided for detecting a translation of the second card from the operative position to the intermediate position. These detecting means may then control means communicating with the second card so as to stop communication with the second card. In this manner, communication with the second card may be stopped while contact exists between the pads thereof and the communicating means. Thus, the second card may be shut down nicely instead of simply removing the contact thereto and communication therewith, such as during communication therewith.

In order to e.g. save space in the telephone, the contacting means may contact the cards from a single side of the overlapping cards. When the cards are overlapping and parallel, parts thereof may extend outside the overlapping area, and electrical contacting may be performed at those positions. In this manner, the card reader(s) may be made more compact.

In one embodiment, the first card is a Subscriber Identification Module and wherein the providing means are adapted to provide subscriber identification and/or communication between the telephone and base stations. Thus, this is the basic operation of a mobile telephone.

In one embodiment, the second card is adapted to hold contact information or other data provided or used by the telephone. When the telephone further comprises a camera, it may be adapted to store information relating to images taken with the camera on the second card. The second card preferably is a MMC card.

In addition or alternatively, the second card may be adapted to store information relating to music or other audio information, and wherein the telephone is adapted to play the music or other audio information.

A second aspect of the invention relates to a method of operating a mobile telephone, the method comprising the steps of:
providing a predetermined activity or functionality of the telephone,
providing and/or storing data to or from a first and a second card each having one or more contacting surfaces or pads,
holding the first and second cards in an operative position, where the cards are at least substantially parallel and at least partly overlap each other,
providing electrical contact to the contacting surfaces or pads of each of the first and second cards,
bringing a preventing means from a first to a second position wherein, in the first position, the preventing means prevents the first card from being removed from the operative position, and in the second position, allowing removal of the first card from the operative position, the preventing means deactivating the providing means when in the second position,
the preventing means, while in its first position, allowing removal of the second card from the operative position.

In a preferred embodiment, the preventing means comprise a battery feeding, in its first position, power so as to facilitate the providing step, wherein the step of bringing the preventing means into the second position comprises removing the battery from the telephone.

Preferably, the preventing means also allowing the removal of the second card when in its second position.

Preferably, the method further comprises the step of translating the first card into the operative position along a linear path, the step of bringing the preventing means from the first to the second position comprising bringing the preventing means from a position in which it blocks the linear path into a position where it does not block the linear path.

In a preferred embodiment, the method further comprises the step of removing the second card by tilting the second card from the operative position into an inoperative position. Also, the step of removing the second card may comprise, before the tilting step, a step of translating the second card from the operative position to an intermediate position. When the second card is prevented from tilting in its operative position, the translating step may remove this blocking and allow the tilting when in the intermediate position.

Preferably, the contacting step comprises contacting the cards from a single side of the overlapping cards.

Normally, the first card is a Subscriber Identification Module and wherein the providing step comprises providing subscriber identification and/or communication between the telephone and base stations. Thus, the normal operation of the telephone may be retained even though the second card is removed or replaced.

In one embodiment, the second card holds contact information or other data provided or used by the telephone. Then, the method may further comprise taking pictures with a camera of the telephone and storing information relating to pictures taken on the second card. The second card may be a MMC card.

Also, the method may then further comprise the steps of to storing, on the second card, information relating to music or other audio information and playing, using the telephone, the music or other audio information.

In the following, a preferred embodiment will be described with reference to the drawing, wherein:

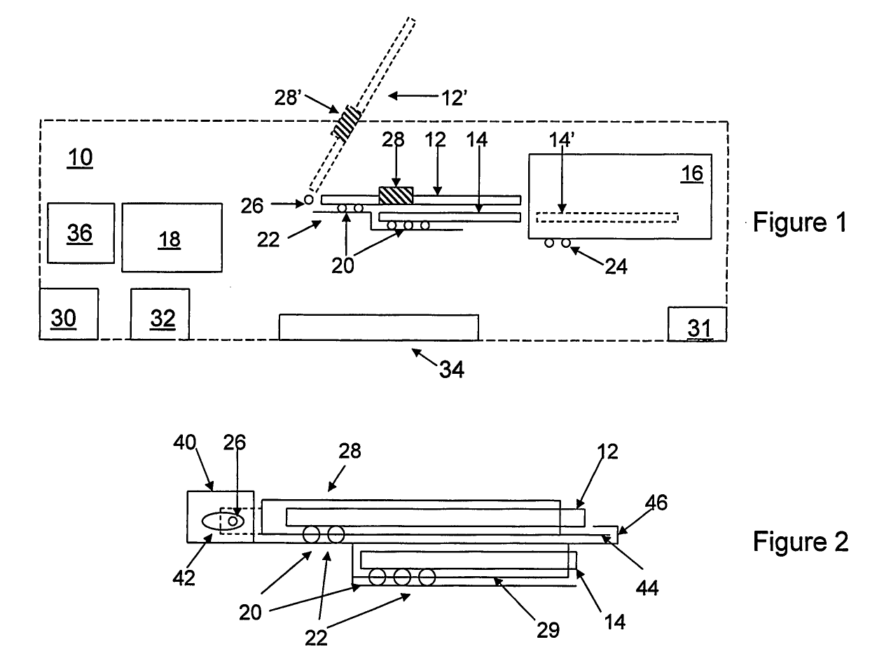

FIG. 1 illustrates a mobile telephone 10 having a first card 14, being a SIM card, and a second card 12, being a MMC card, and

FIG. 2 illustrates the tiltable holding means for the second card.

In FIG. 1, the cards 12 and 14, in the operative position in which they are denoted 12 and 14, the cards 12 and 14 are parallel and overlap one another. The cards 12 and 14 are contacted by contacts 20 provided on a surface 22 in the telephone. These contacts 20 provide the normal data flow between the cards 12 and 14 and the remainder of the telephone 10.

The telephone 10 further comprises a battery 16 and means 18 for providing the telephone operation, such as the scanning of whether a telephone call is desired, handling telephone conversations and the like. The means 18 use the SIM card 14 for identifying the user of the telephone 10.

The battery 16, in operation, is positioned in the telephone 10 and is contacted by contacts 24 in order to provide power to the telephone, hereunder the means 18.

Removal of the SIM card 14 is provided by translating the card away from the contacts 20 to a position denoted 14′. It is seen that the battery 16 blocks this position, whereby the SIM card 14 may only be removed after removal of the battery. Naturally, removing the battery 16 will remove the power from the telephone 10 and the means 18, whereby the operation of the means 18 is then interrupted.

However, it is desired that the card 12 may, in fact, be removed or replaced while allowing the means 18 to operate. The card 12 may be used for storing music or images, where the music or other audio signals may be recorded by a microphone 31—or recorded on the card 12 outside the telephone 10, and played to the user via either the normal speaker 30 of the telephone 10 or an additional (such as a more powerful) speaker 32 thereof. The images may be provided on a display 34 of the telephone 10, which may also have a camera 36 for taking pictures for storage on the card 12 and providing on the display 34.

It should be noted that the opposite may also be desired in the present embodiment: the possibility of removing or replacing the SIM card while maintaining the other (MMC) card in the telephone, such as when playing music therefrom or when using the telephone as a camera storing the images on the MMC card. Then, the MMC card can only be removed when the camera/playing functionality is stopped using the preventing means. Thus, the positions and operation of the two cards may be interchanged in the present invention.

When wishing to replace the data on the card 12, the card 12 is tilted from its operational position to the position 12′ in which the card no more contacts the contacts 20 and from which the card 12 may be removed from the telephone 10. It is seen that the battery 16 does not block the removal of the card 12 in the position 12′.

The tilting of the card 12 is provided by holding/tilting means 28 and 28′ (denoting the position from which the card 12 may be removed) which tilts the card 12 around an axis pointed to by the arrow 26. This is more elaborately described in relation to FIG. 2.

Thus, the card 12 may be removed so as to be emptied or reloaded with other data for use in the telephone, such as a revised telephone book, music, pictures or other information, without rendering the telephone inactive, so that incoming telephone conversations, SMS'es etc. can still be received.

It is clear that instead of having the battery 16 block the path of the card 14 as the preventing means, a switch or other mechanical element may block this path in a manner so that, when removed or displaced, the operation of the means 18 may be interrupted, such as by cutting a power feed thereto or in any other suitable manner.

The holding means 28 schematically illustrated in FIG. 1 are more clearly depicted in FIG. 2. It is seen that the card 12 extends slightly out of the means 28 at one end from the means 28 which, at an opposite end extends to the axis 26 where the means 28 has a part extending into a slot 42 provided in a part 40 attached to the surface 22.

At the opposite end of the card 12, the means 28 comprise an extension 44 extending, in the position illustrated, into a stopper 46 which prevents the means 28 from tilting upwardly around the axis 26.

In this preferred embodiment, the means 28 are made of steel in order to both provide a suitable holding and movement of the card 12 and so as to magnetically/electrically shield the card 12 from the surroundings. It is seen that the means 28 form a container for the card 12 covering a majority of the surface of the card 12 and thus, provides a good shielding. Naturally, the steel may be both solid steel or sheet steel with holes or openings therein. Also the card 14 is provided in a holding means 29 also covering the majority of the outer surface of the card 14 and providing a magnetic/electric shielding of the card 14 from the surroundings.

The operation of the tilting is firstly a translation, to the left on the figure, of means 28, and consequently the axis 26. It is seen that the slot 42 facilitates this translation. Then, the extension 44 will be translated out of the stopper 46, whereby the means 28 and the card 12 will be tiltable.

An advantage of this translation of the card 12 is the fact that the contacting surfaces (not illustrated) of the card 12 will be translated against the contacts 20, whereby these contact surfaces will be cleaned prior to use.

Naturally, the stopper 46 or another means may additionally serve the function of blocking translation of the card 12 out of the means 28 while in the illustrated position.

It may be desired to be able to detect possible removal of the card 12, whereby a switch may be present at the means 28 so as to detect translation/tilting thereof or so as to detect the removal of a cover covering the access opening of the telephone 10 for the cards 12 and 14. This detection may be made in time for the card(s) to be closed down for removal instead of risking loss of data or the integrity of the card by removal thereof during data communication with the telephone.

1. A mobile telephone comprising:
means for providing a predetermined activity or functionality of the telephone,
a first and a second data providing and/or storing card each having one or more contacting surfaces or pads,
means for holding the first and second cards in an operative position, where the cards are at least substantially parallel and at least partly overlap each other,
means for contacting the contacting surfaces or pads of each of the first and second cards,
preventing means having two positions, a first of the positions preventing the first card from being removed from the operative position, and the second position allowing removal of the first card from the operative position,
the preventing means being adapted to deactivate the providing means when in the second position,
the preventing means, in its first position, allowing removal of the second card from the operative position.

2. A telephone according to claim 1, wherein the preventing means comprise a battery feeding power to the providing means in its first position, the second position being a position in which the battery has been removed from the telephone.

3. A telephone according to claim 1, wherein the first card is translatable into and out of the operative position along a linear path, the preventing means, when in its first position, blocking the linear path out of the operative position.

4. A telephone according to claim 1, further comprising means for removing the second card, the removing means being adapted to allow tilting of the second card from the operative position into an inoperative position.

5. A telephone according to claim 1, wherein the contacting means contact the cards from a single side of the overlapping cards.

6. A telephone according to claim 1, wherein the first card is a Subscriber Identification Module and wherein the providing means are adapted to provide subscriber identification and/or communication between the telephone and base stations.

7. A telephone according to claim 1, wherein the second card is an MMC card.

8. A telephone according to claim 4, wherein the removing means are further adapted to translate the second card, prior to tilting, from the operative position into an intermediate position, the telephone further comprising means for preventing tilting of the second card when in the operative position and allowing tilting of the second card when in the intermediate position.

9. A method of operating a mobile telephone, the method comprising the steps of:
providing a predetermined activity or functionality of the telephone,
providing and/or storing data to or from a first and a second card each having one or more contacting surfaces or pads,
holding the first and second cards in an operative position, where the cards are at least substantially parallel and at least partly overlap each other,
providing electrical contact to the contacting surfaces or pads of each of the first and second cards,
bringing a preventing means from a first to a second position wherein, in the first position, the preventing means prevents the first card from being removed from the operative position, and in the second position, allowing removal of the first card from the operative position,
the preventing means deactivating the providing means when in the second position, the preventing means, while in its first position, allowing removal of the second card from the operative position.

10. A method according to claim 9, wherein the preventing means comprise a battery feeding, in its first position, power so as to facilitate the providing step, wherein the step of bringing the preventing means into the second position comprises removing the battery from the telephone.

11. A method according to claim 9, further comprising the step of removing the second card by tilting the second card from the operative position into an inoperative position.
